(19) United States
(12) Patent Application Publication
(10) Pub. No.: US 2026/0369444 A1
(43) Pub. Date: Nov. 19, 2026

(54) CONDUCTIVE MODULE AND POWER CONNECTOR

(71) Applicant: BIZLINK INTERNATIONAL CORP., New Taipei City (TW)

(72) Inventors: Su Ken HSIAO, New Taipei City (TW); Chang-Hsien TUNG, New Taipei City (TW)

(21) Appl. No.: 19/676,844

(22) Filed: May 14, 2026

(30) Foreign Application Priority Data
May 15, 2025 (TW) 114204947

(51) Int. Cl. H01B 5/12; H01B 1/02; H01B 7/00; H01B 7/04; H01B 7/06; H01R 9/11

(52) U.S. Cl. CPC H01B 5/12; H01B 1/026; H01B 7/0018; H01B 7/04; H01B 7/06; H01R 9/11

(57) ABSTRACT

The present disclosure relates to a conductive module for a power connector. The conductive module includes two conductive members. Each of the two conductive members includes a front fixing portion, a rear fixing portion, and a twining portion connected between the front fixing portion and the rear fixing portion. The twining portions of the two conductive members are intertwined with each other to define a plurality of crossing segments.

### CROSS-REFERENCE TO RELATED APPLICATION

This application claims priority to Taiwan Application Serial Number 114204947, filed May 15, 2025, which is herein incorporated by reference in its entirety.

### BACKGROUND

### Field of Invention

The present disclosure relates to a conductive module and a power connector. More particularly, the present disclosure relates to a conductive module and a power connector capable of flexibly connecting a server chassis busbar to a server.

### Description of Related Art

Generally, when a server is installed in a server chassis, it is connected to the busbar via a busbar connector. To avoid connection failures due to varying server specifications, such as busbar connectors being too short or servers not being properly aligned, existing busbar connectors (such as the GB300 from BzLisa360S) use flexible copper busbars as cable assemblies that can be bent as needed during installation. However, the design of the flexible copper busbar has limited potential for length extension, and increasing the length also leads to issues such as increased volume and the need for additional installation space.

### SUMMARY

The present disclosure relates to a conductive module for a power connector. The conductive module includes two conductive members. Each of the two conductive members includes a front fixing portion, a rear fixing portion, and a twining portion connected between the front fixing portion and the rear fixing portion. The twining portions of the two conductive members are intertwined with each other to define a plurality of crossing segments.

The present disclosure also relates to a power connector. The power connector includes a housing, two terminal modules, and two conductive modules. The housing defines an insertion slot. The two terminal modules are respectively disposed within the housing. Each of the two terminal modules is partially exposed from the insertion slot. The two terminal modules are disposed facing each other. The two conductive modules are respectively connected to one of the two terminal modules. Each of the two conductive modules includes two conductive members. Each of the two conductive members includes a front fixing portion, a twining portion, and a rear fixing portion. The twining portions of the two conductive members are intertwined with each other to define a plurality of crossing segments.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a power connector according to an embodiment of the present disclosure;

FIG. 2 is a schematic diagram of a conductive module according to an embodiment of the present disclosure;

FIG. 3 is a schematic diagram of a conductive member according to an embodiment of the present disclosure;

FIG. 4 is a schematic diagram of another conductive member according to another embodiment of the present disclosure;

FIGS. 5A-5C are schematic diagrams illustrating the twining steps of the conductive module according to an embodiment of the present disclosure;

FIG. 6 is a schematic diagram of another power connector according to another embodiment of the present disclosure;

FIG. 7 is an actual photo of the another power connector according to another embodiment of the present disclosure; and

FIG. 8 is an actual photo of the another power connector according to another embodiment of the present disclosure.

### DETAILED DESCRIPTION

The following description provides numerous different embodiments or examples for implementing various features of the subject matter provided herein. The following description of specific examples of components and arrangements is provided to simplify the present disclosure. Of course, these are merely examples and are not intended to be limiting. Furthermore, the present disclosure may repeat component symbols and/or letters in various examples. Such repetition is for the purposes of simplification and clarity and does not in itself indicate any relationship between the various embodiments and/or configurations described.

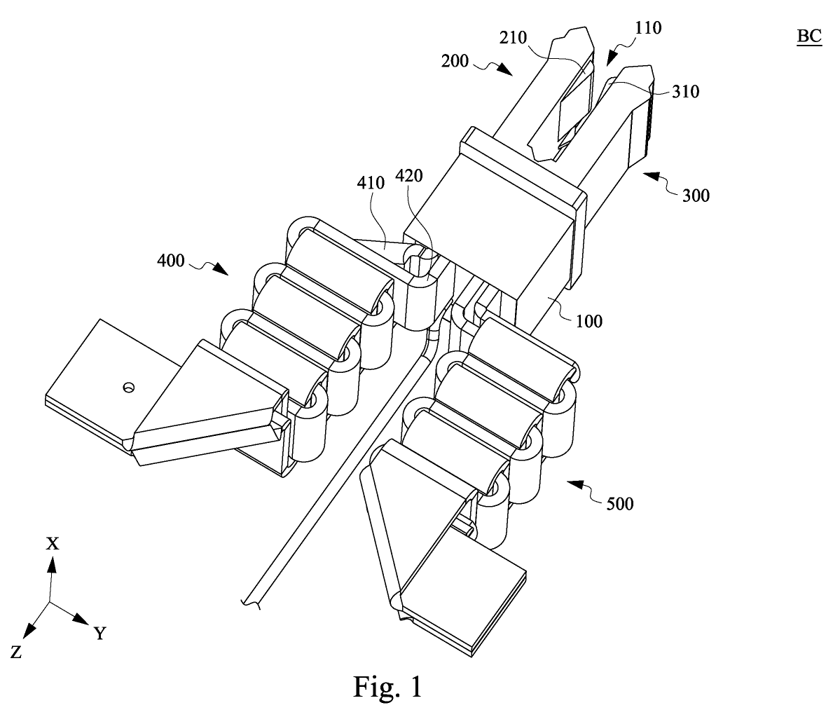

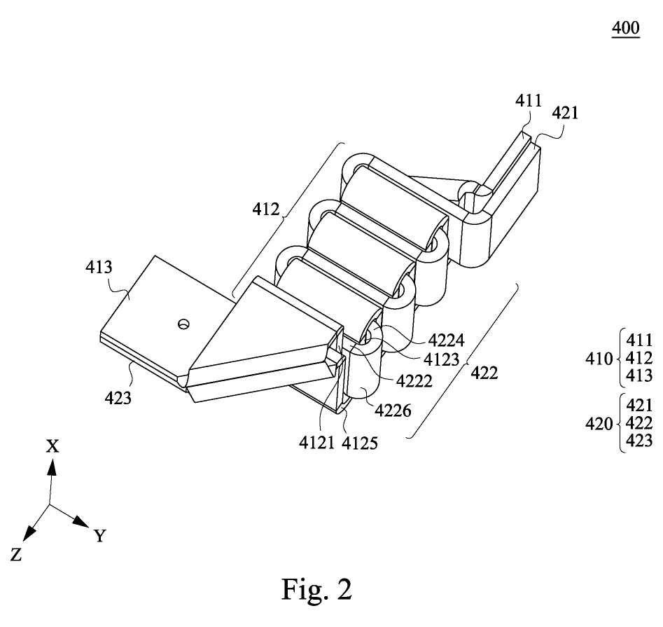

Furthermore, FIGS. 1 and 2 are drawn to actual scale. To keep this specification concise, the proportions of the individual components are not listed one by one. However, the proportions and positions of the components should be considered part of this specification. The following sections will describe in detail structures, functions, and interconnections of the components included in a power connector BC, which is an embodiment of the present disclosure.

To enable the reader to clearly understand the relative positions and orientations of the various components more clearly, the drawings use a first axis X, a second axis Y, and a third axis Z.

Please refer to FIG. 1, which is a schematic diagram of a power connector BC according to an embodiment of the present disclosure. The present disclosure provides a power connector BC that can be applied, for example, to a server chassis to connect a busbar. In an embodiment of the present disclosure, the power connector BC is a clamp-type busbar connection device. However, in other embodiments, it may also be applied to other forms of busbar connection devices, such as crimp-type busbar connection devices, slide-rail-type busbar connection devices, and the like.

In some embodiments, the power connector BC includes a housing 100, a first terminal module 200, a second terminal module 300, a first conductive module 400, and a second conductive module 500. The first terminal module 200 and the second terminal module 300 are respectively disposed within the housing 100. The first conductive module 400 is connected to the first terminal module 200. The second conductive module 500 is connected to the second terminal module 300.

In some embodiments, the housing 100 includes an insertion slot 110. Each of the first terminal module 200 and the second terminal module 300 include respective head 210 and head 310. The head 210 and head 310 protrude from the insertion slot 110 of the housing 100 and are arranged to face each other.

Please refer to FIG. 2, which is a schematic diagram of a first conductive module 400 according to an embodiment of the present disclosure. Since the first conductive module 400 and the second conductive module 500 have the same structure, FIG. 2 uses the first conductive module 400 as an example to illustrate the conductive module of the present disclosure.

In some embodiments, the first conductive module 400 at least includes a first conductive member 410 and a second conductive member 420. The first conductive member 410 and the second conductive member 420 are respectively integrally formed sheet-shaped cables arranged in an interlaced configuration. Specifically, the first conductive member 410 and the second conductive member 420 are interwoven in a mutually twined method to form the interlaced configuration.

In some embodiments, the first conductive member 410 includes a front fixing portion 411, a twining portion 412, and a rear fixing portion 413, and is connected to the first terminal module 200 via the front fixing portion 411 (shown in FIG. 1). The second conductive member 420 includes a front fixing portion 421, a twining portion 422, and a rear fixing portion 423, and is connected to the first terminal module 200 via the front fixing portion 421 (shown in FIG. 1).

In some embodiments, the front fixing portion 411 of the first conductive member 410 and the front fixing portion 421 of the second conductive member 420 are arranged in parallel. Specifically, the front fixing portion 411 and the front fixing portion 421 are arranged in parallel and overlap, while simultaneously connecting to the first terminal module 200 (shown in FIG. 1).

In some embodiments, the first conductive member 410 and the second conductive member 420 are arranged in an interlaced method by twining the twining portion 412 and the twining portion 422 against one another to form the interlaced configuration. The twining portion 412 and the twining portion 422 are twined around one another. When the first conductive module 400 transitions from a contracted state shown in FIG. 2 to an extended state (not shown), a distance between the front fixing portion 411 and the rear fixing portion 413 (also between the front fixing portion 421 and the rear fixing portion 423) increases. Simultaneously, a space between the twining portion 412 of the first conductive member 410 and the twining portion 422 of the second conductive member 420 increases.

In other words, because the twining portions twine in an interlaced and overlapping arrangement, the conductive module possesses an extensible characteristic. When the conductive module is extended, the distance between the front fixing portion and the rear fixing portion of the conductive member is increased. At this time, the twining portions, which were twined in the interlaced and overlapping arrangement in the contracted state, provide the elasticity and length required for extension.

In some embodiments, the first conductive member 410 sequentially includes a first plate portion 4121 and a third plate portion 4123 connected via a first bend portion 4125. The second conductive member 420 sequentially includes a second plate portion 4222 and a fourth plate portion 4224 connected via a second bend portion 4226. The second plate portion 4222 is located between the first plate portion 4121 and the third plate portion 4123. The third plate portion 4123 is located between the second plate portion 4222 and the fourth plate portion 4224.

In some embodiments, the rear fixing portion 413 of the first conductive member 410 and the rear fixing portion 423 of the second conductive member 420 are arranged in parallel. Specifically, the rear fixing portion 413 and the rear fixing portion 423 are arranged in parallel and overlap, while simultaneously connecting other components (not shown).

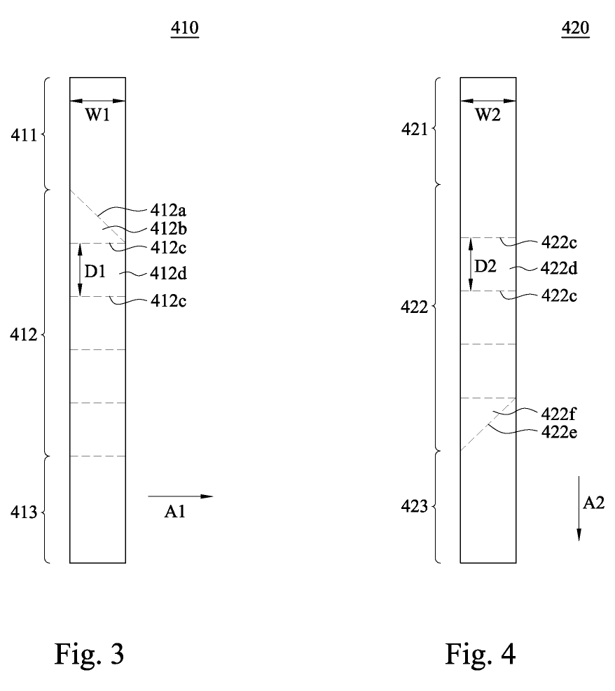

Please refer to FIG. 3, which is a schematic diagram of the first conductive member 410. The twining portion 412 of the first conductive member 410 has a front twining base line 412a. The front twining base line 412a is located near the front fixing portion 411 and is inclined to a first direction A1. The twining portion 412 of the first conductive member 410 has a plurality of intermediate twining base lines 412c between the front twining base line 412a and the rear fixing portion 413. Each of the intermediate twining base lines 412c is spaced apart from the others by an equal distance D1. A front crossing segment 412b is provided between the front twining base line 412a and an adjacent intermediate twining base line 412c. An intermediate crossing segment 412d is provided between two adjacent intermediate twining base lines 412c. In some embodiments, the first conductive member 410 has a width W1. A width of the width W1 is equal to a length of the distance D1.

In some embodiments, when the first conductive member 410 is twined for the first time along the front twining base line 412a, the front fixing portion 411 remains perpendicular to the first direction A1, the twining portion 412 and the rear fixing portion 413 will bend in a direction parallel to the first direction A1, causing the twining portion 412 and the rear fixing portion 413 to be perpendicular to the front fixing portion 411. After the first conductive member 410 undergoes the first twining operation, it is then bent along the intermediate twining base line 412c adjacent to the front twining base line 412a, in the first direction A1 and in a direction opposite to the first bend. Similarly, the twining portion 412 of the first conductive member 410 is bent back and forth along multiple intermediate twining base lines 412c in the first direction A1.

Please refer to FIG. 4, which is a schematic diagram of the second conductive member 420. The twining portion 422 of the second conductive member 420 has a rear twining base line 422e. The rear twining base line 422e is inclined to a second direction A2 and is located near the rear fixing portion 423. The twining portion 422 of the second conductive member 420 has a plurality of intermediate twining base lines 422c between the rear twining base line 422e and the front fixing portion 421. Each of the intermediate twining base lines 422c is spaced apart from the others by an equal distance D2. An intermediate crossing segment 422d is provided between two adjacent intermediate twining base lines 422c. A rear crossing segment 422f is provided between the rear twining base line 422e and an adjacent intermediate twining base line 422c. In some embodiments, the second conductive member 420 has a width W2. A width of the width W2 is equal to a length of the distance D2.

In some embodiments, when the second conductive member 420 is twined upward for the first time along the intermediate twining base line 422c adjacent to the front fixing portion 421 and along the second direction A2, the twining portion 422 and the rear fixing portion 423 bend toward the front fixing portion 421 along the second direction A2. At this point, the twining portion 422 and the rear fixing portion 423 will cover the front fixing portion 421. Similarly, the twining portion 422 of the second conductive member 420 will be bent back and forth along the intermediate twining base lines 422c in the second direction A2. After the second conductive member 420 has been twined several times, it is finally bent along the rear twining base line 422e in a direction perpendicular to the second direction A2, so that the rear fixing portion 423 is perpendicular to the second direction A2.

In some embodiments, the width W1 of the first conductive member 410 is the same as the width W2 of the second conductive member 420. To accommodate the interlocking of the width W1 and the width W2, the distance D1 of the first conductive member 410 and the distance D2 of the second conductive member 420 are designed to be the same as the width W1 and the width W2, respectively.

Specifically, the twining portion 412 of the first conductive member 410 includes a plurality of intermediate crossing segments 412d. The twining portion 422 of the second conductive member 420 likewise includes a plurality of intermediate crossing segments 422d. In the direction of extension of the first conductive member 410 and the second conductive member 420, the intermediate crossing segments 412d and 422d are arranged in an interlaced method by being twined alternately.

The first plate portion 4121 and the third plate portion 4123 of the first conductive member 410 may each be one of two adjacent intermediate crossing segments 412d. The first bend portion 4125 connecting the two adjacent intermediate crossing segments 412d may be the intermediate twining base line 412c connecting the two adjacent intermediate crossing segments 412d. The second plate portion 4222 and the fourth plate portion 4224 of the second conductive member 420 may each be one of two adjacent intermediate crossing segments 422d. The second bend portion 4226 connecting the two adjacent intermediate crossing segments 422d may be the intermediate twining base line 422c connecting the two adjacent intermediate crossing segments 422d.

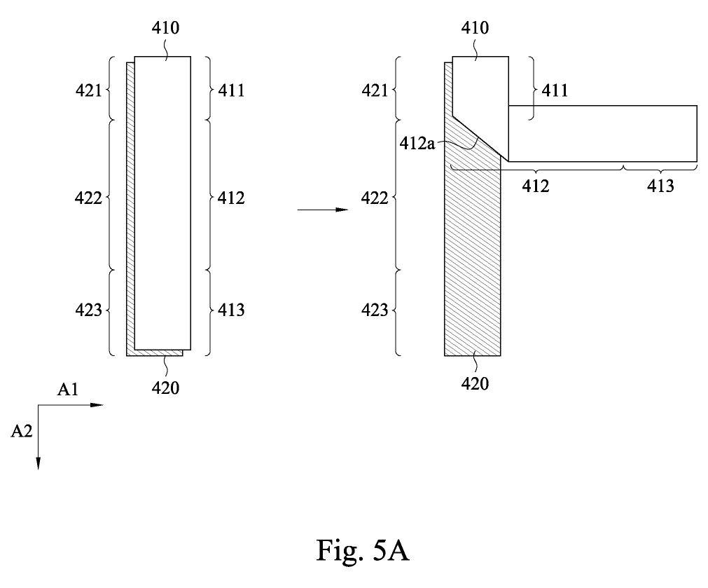

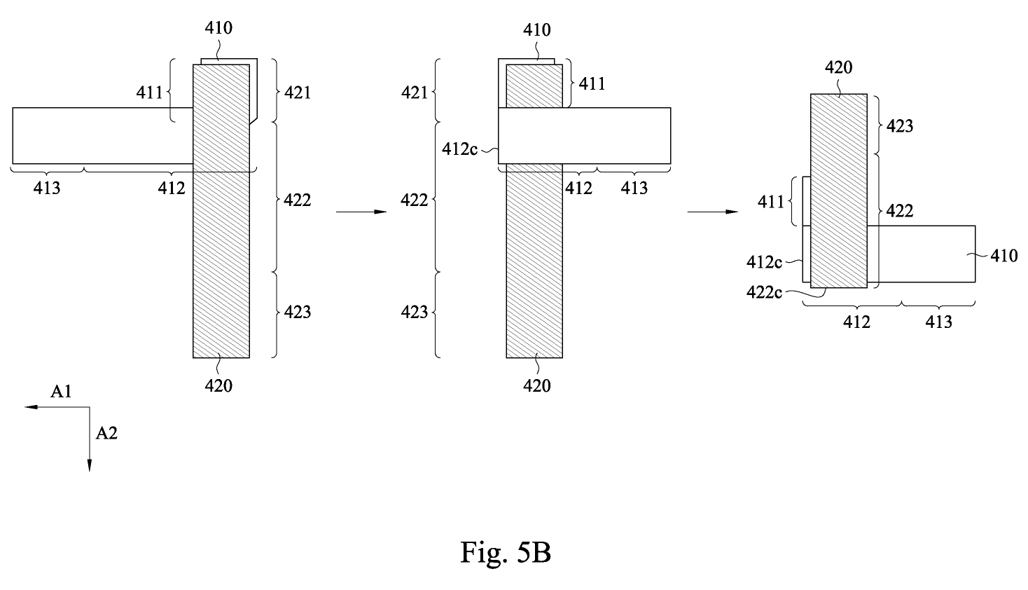

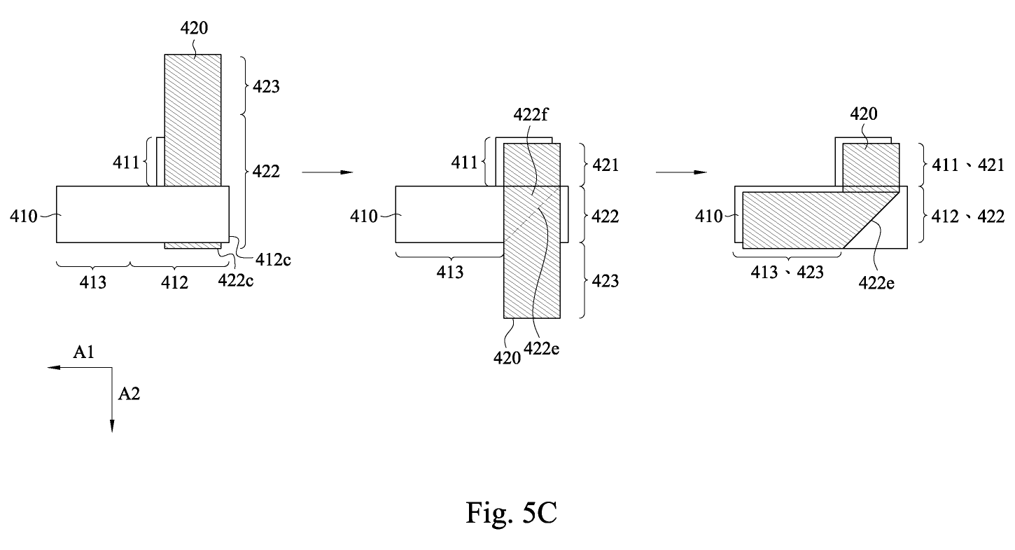

Please refer to FIGS. 5A-5C, which illustrate the twining steps for the first conductive module 400. The following description should be read in conjunction with FIGS. 3 and 4. The detailed structures depicted in FIGS. 3 and 4 are not shown in FIGS. 5A-5C. As shown in FIGS. 5A-5C, the first direction A1 is perpendicular to the second direction A2.

Furthermore, to clearly illustrate the twining steps in FIGS. 5A-5C, the first conductive member 410 and the second conductive member 420 are not arranged in complete overlap. However, in actual embodiments, the first conductive member 410 and the second conductive member 420 are neatly overlapped.

In FIG. 5A, the first conductive member 410 and the second conductive member 420 are initially arranged in an overlapping configuration along the second direction A2. The front fixing portion 411, the twining portion 412, and the rear fixing portion 413 of the first conductive member 410 respectively correspond to the front fixing portion 421, the twining portion 422, and the rear fixing portion 423 of the second conductive member 420. Next, the first conductive member 410 is twined for the first time along the front twining base line 412a, such that the twining portion 412 and the rear fixing portion 413 of the first conductive member 410 are parallel to the first direction A1. As a result, the twining portion 412 of the first conductive member 410 is perpendicular to the twining portion 422 of the second conductive member 420, facilitating the subsequent interlacing twining operation.

Rotate the first conductive module 400 shown in FIG. 5A by 180 degrees along the first direction A1, as shown in FIG. 5B. Next, rotate the first conductive member 410 along the first intermediate twining base line 412c, which is adjacent to the front twining base line 412a, bend it to the right along the first direction A1, and twine the twining portion 412 of the first conductive member 410 over the twining portion 422 of the second conductive member 420.

Next, bend the second conductive member 420 upward along the second direction A2, using the first intermediate twining base line 422c adjacent to the front fixing portion 421, so that the twining portion 422 of the second conductive member 420 twines over the twining portion 412 of the first conductive member 410.

Next, please refer to FIGS. 5B and 5C in sequence. Using the method described above, the twining portion 412 of the first conductive member 410 is bent back and forth in the first direction A1, and the twining portion 422 of the second conductive member 420 is bent back and forth in the second direction A2, so that they are interwoven, allowing the twining portion 412 of the first conductive member 410 and the twining portion 422 of the second conductive member 420 to be arranged in an interlaced configuration.

Finally, please refer to FIG. 5C. When the twining portion 412 of the first conductive member 410 and the twining portion 422 of the second conductive member 420 are about to complete twining, twin the second conductive member 420 along the rear twining base line 422e and bend the rear fixing portion 423 of the second conductive member 420 to the left along the first direction A1, so that the rear fixing portion 423 of the second conductive member 420 is parallel to and overlaps with the rear fixing portion 413 of the first conductive member 410, thereby connecting to other terminal assemblies.

The conductive module (or cable module) woven according to the above description not only significantly increases the cable length, but also, by interweaving the conductive members (which may be flat-shaped cables) in a twined method, provides the conductive module with greater elasticity, allowing it to be adjusted to accommodate different connection distance requirements. Furthermore, due to the characteristics of the twined cable structure, it does not increase the space required for housing.

The twining method described above for the first conductive member 410 and the second conductive member 420 is one embodiment of the present disclosure. In other embodiments, the first conductive member 410 may simultaneously have a front twining base line 412a and a rear twining base line (not shown), or the second conductive member 420 may simultaneously have a front twining base line (not shown) and a rear twining base line 422e. The present disclosure is not limited thereto. In other embodiments, adjustments may be made as needed based on the lengths and braiding configurations of the twining portion 412 of the first conductive member 410 and the twining portion 422 of the second conductive member 420.

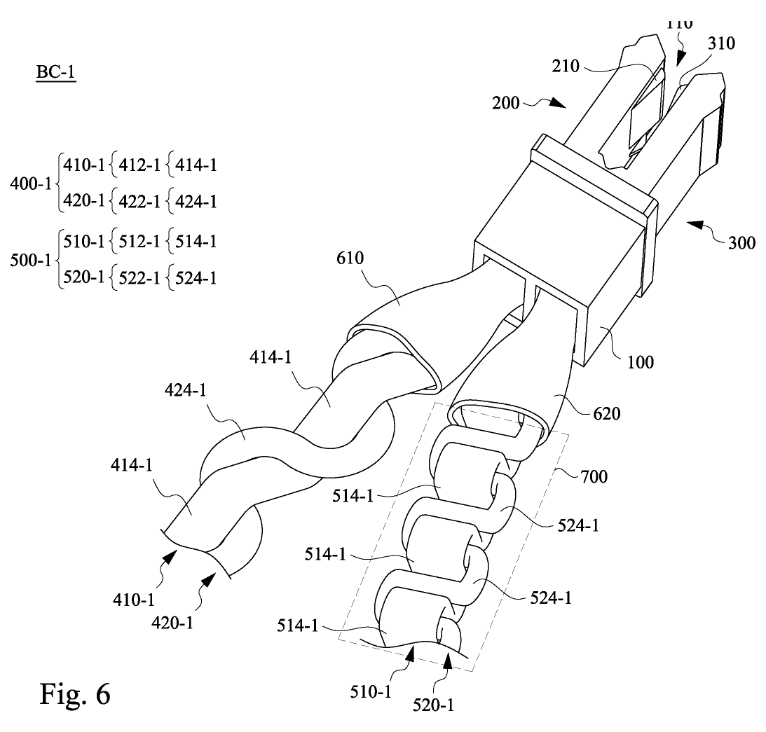

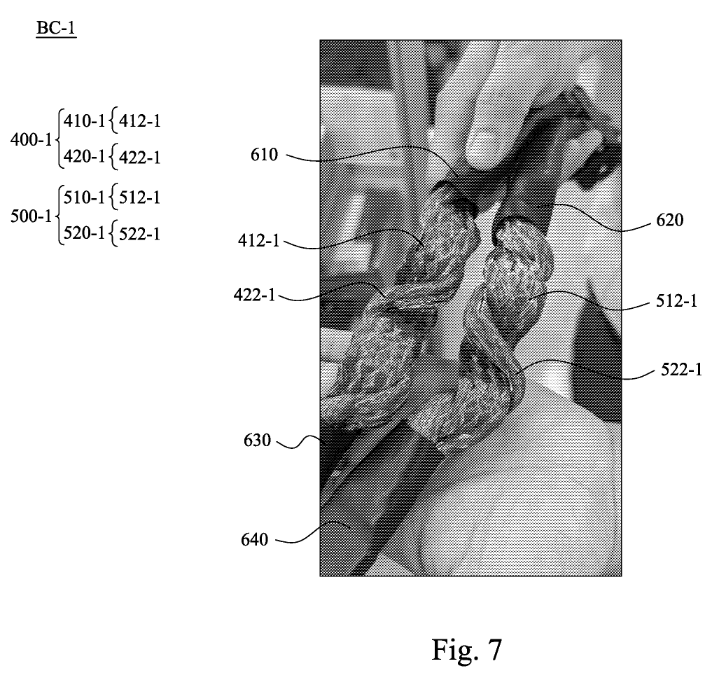

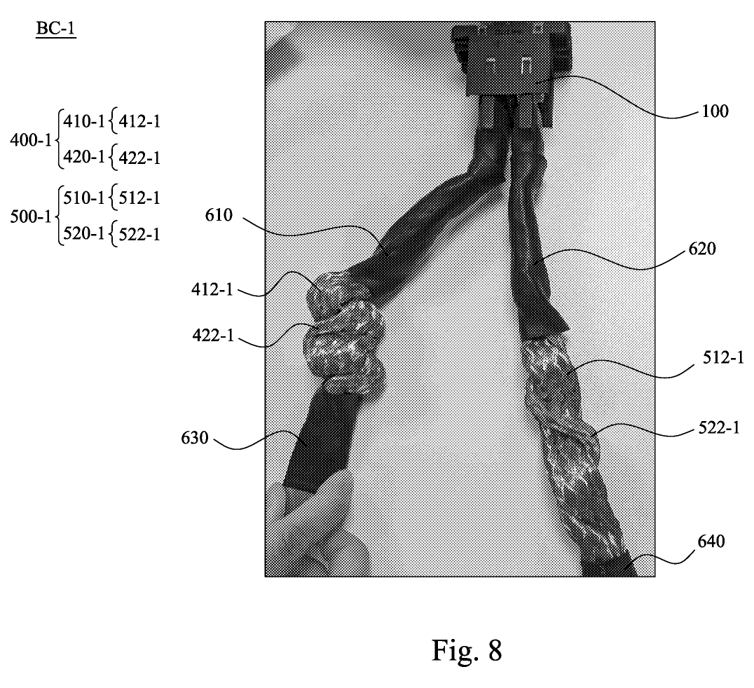

Please refer to FIGS. 6-8. FIG. 6 is a schematic diagram of a power connector BC-1 according to an embodiment of the present disclosure. FIGS. 7 and 8 are actual photos of the power connector BC-1 according to an embodiment of the present disclosure.

In some embodiments, the power connector BC-1 includes a housing 100, a first terminal module 200, a second terminal module 300, a first conductive module 400-1, and a second conductive module 500-1. The first terminal module 200 and the second terminal module 300 are respectively disposed within the housing 100. The two conductive modules are respectively connected to one of the two terminal modules. In particular, the first conductive module 400-1 is connected to the first terminal module 200, and the second conductive module 500-1 is connected to the second terminal module 300. Structures and configurations of the housing 100, the first terminal module 200, and the second terminal module 300 of the power connector BC-1 are identical to those of the power connector BC.

In some embodiments, the first conductive module 400-1 and the first terminal module 200 can be connected using screws or by soldering. The same applies to the second conductive module 500-1 and the second terminal module 300.

In some embodiments, the housing 100 of the power connector BC-1 defines an insertion slot 110. The first terminal module 200 and the second terminal module 300 are respectively disposed within the housing 100. One end of each of the first terminal module 200 and the second terminal module 300 partially exposes from the insertion slot 110. The ends of the first terminal module 200 and the second terminal module 300 are disposed facing each other.

In some embodiments, each of the two conductive modules includes two conductive members. In particular, the first conductive module 400-1 includes a first conductive member 410-1 and a second conductive member 420-1. The second conductive module 500-1 includes a first conductive member 510-1 and a second conductive member 520-1.

In some embodiments, each of the two conductive members includes a front fixing portion, a twining portion, and a rear fixing portion. In FIGS. 6-8, the front fixing portions of the first conductive member 410-1 and the second conductive member 420-1 are covered by an insulating member 610 and insert into the housing 100. The front fixing portions of the first conductive member 510-1 and the second conductive member 520-1 are covered by an insulating member 620 and insert into the housing 100. In FIGS. 7-8, the rear fixing portions of the first conductive member 410-1 and the second conductive member 420-1 are covered by an insulating member 630. The rear fixing portions of the first conductive member 510-1 and the second conductive member 520-1 are covered by an insulating member 640. The insulating members 610, 620, 630, and 640 includes, but is not limited to, an insulating tape or other suitable flexible insulating materials.

In some embodiments, the twining portions of the two conductive members are intertwined with each other to define a plurality of crossing segments. In FIGS. 6-8, the twining portion 412-1 of the first conductive member 410-1 and the twining portion 422-1 of the second conductive member 420-1 are intertwined with each other to define a plurality of crossing segments. The twining portion 412-1 includes a plurality of crossing segments 414-1. The twining portion 422-1 includes a plurality of crossing segments 424-1. The twining portion 512-1 of the first conductive member 510-1 and the twining portion 522-1 of the second conductive member 520-1 are intertwined with each other to define a plurality of crossing segments. The twining portion 512-1 includes a plurality of crossing segments 514-1. The twining portion 522-1 includes a plurality of crossing segments 524-1.

In some embodiments, the crossing segments of one of the two conductive members are arranged in an interlaced configuration with the crossing segments of the other of the two conductive members. In particular, the crossing segments 414-1 of the first conductive member 410-1 are arranged in the interlaced configuration with the crossing segments 424-1 of the second conductive member 420-1. The crossing segments 514-1 of the first conductive member 510-1 are arranged in the interlaced configuration with the crossing segments 524-1 of the second conductive member 520-1.

In some embodiments, the twining portions of the two conductive members are intertwined with each other in a double-helix manner. In particular, the twining portion 412-1 of the first conductive member 410-1 and the twining portion 422-1 of the second conductive member 420-1 are arranged in the double-helix configuration. The twining portion 512-1 of the first conductive member 510-1 and the twining portion 522-1 of the second conductive member 520-1 are arranged in the double-helix configuration.

In some embodiments, each of the two conductive members is a flexible braided conductive strap having a flat ribbon shape. The flexible braided strap is formed by a plurality of conductive wire sets interlaced with each other. Each of the plurality of conductive wire sets comprises a plurality of braided conductive wires. In particular, the first conductive member 410-1, the second conductive member 420-1, the first conductive member 510-1, and the second conductive member 520-1 are flat ribbon-shaped, respectively.

In some embodiments, when each of the two conductive modules transitions from a contracted state to an extended state, a distance between the front fixing portion and the rear fixing portion of each of the two conductive members in an extended state is greater than that in a contracted state. Upon transition of the conductive module from the contracted state to the extended state, a space defined between two adjacent crossing segments of the twining portions of each of the two conductive members in the extended state is greater than that in contracted state. In other words, the twining portion extends and the rear fixing portion is extended away from the housing in the extended state.

In some embodiments, the first conductive module 400-1 shown in FIG. 6 is in the extended state and the second conductive module 500-1 shown in FIG. 6 is in the contracted state. Conversely, the first conductive module 400-1 shown in FIG. 8 is in the contracted state and the second conductive module 500-1 shown in FIG. 8 is in the extended state.

In FIG. 6, a space defined between two adjacent crossing segments 414-1 of the twining portion 412-1 of the first conductive member 410-1 in the extended state is greater than a space defined between two adjacent crossing segments 514-1 of the twining portion 512-1 of the first conductive member 510-1 in contracted state.

In FIG. 8, a distance between the front fixing portions covered by the insulating member 620 and the rear fixing portions covered by the insulating member 640 of the first conductive member 510-1 and the second conductive member 520-1 in the extended state is greater than a distance between the front fixing portions covered by the insulating member 610 and the rear fixing portions covered by the insulating member 630 of the first conductive member 410-1 and the second conductive member 420-1 in the contracted state.

In FIG. 8, the twining portion 512-1 of the first conductive member 510-1 and the twining portion 522-1 of the second conductive member 520-1 extend and the rear fixing portions covered by the insulating member 640 are extended away from the housing 100 in the extended state.

In some embodiments, the twining portions of the two conductive members are bent back and forth to interlace with each other. In other words, the twining portions of the two conductive members are flexible and bent in a serpentine manner to interlace with each other. In particular, the twining method involving bending the twining portions 412-1, 422-1, 512-1, and 522-1 back and forth is similar to the twining method described in FIGS. 5A-5B.

In some embodiments, the power connector BC-1 further includes a flexible protection member covering the twining portions of the two conductive members. The flexible protection member is configured to expand and contract to correspond to the contracted state and the extended state of the conductive module. The flexible protection member may be an expandable insulating sleeve. As shown in FIG. 6, the flexible protection member 700 covers the twining portion 512-1 of the first conductive member 510-1 and the twining portion 522-1 of the second conductive member 520-1. Depending on actual requirements, the flexible protection member 700 can adaptively adjust its coverage area on the conductive members. The flexible protection member 700 may be a telescopic sleeve or other suitable flexible material.

In some embodiments, each of the two conductive members is a braided structure formed by a plurality of conductive wire sets. Each of the plurality of conductive wire sets includes a plurality of braided conductive wires. The plurality of conductive wires may be made of copper.

In summary, the power connector of the present disclosure uses the conductive module arranged in an intertwined configuration. This increases the conductive module’s length without requiring additional space for accommodating the conductive module and allows the conductive module extend and retract flexibly to properly accommodate servers of different specifications.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A conductive module for a power connector comprising:
two conductive members, each of the two conductive members comprising a front fixing portion, a rear fixing portion, and a twining portion connected between the front fixing portion and the rear fixing portion;
wherein the twining portions of the two conductive members are intertwined with each other to define a plurality of crossing segments.

2. The conductive module of claim 1, wherein each of the two conductive members is a flexible braided conductive strap having a flat ribbon shape.

3. The conductive module of claim 2, wherein the flexible braided strap is formed by a plurality of conductive wire sets interlaced with each other.

4. The conductive module of claim 3, wherein each of the plurality of conductive wire sets comprises a plurality of braided conductive wires.

5. The conductive module of claim 4, wherein the plurality of conductive wires are made of copper.

6. The conductive module of claim 1, wherein when the conductive module transitions from a contracted state to an extended state, a distance between the front fixing portion and the rear fixing portion of each of the two conductive members in an extended state is greater than that in a contracted state.

7. The conductive module of claim 6, wherein upon transition of the conductive module from the contracted state to the extended state, a space defined between two adjacent crossing segments of the twining portions of each of the two conductive members in the extended state is greater than that in the contracted state.

8. The conductive module of claim 6, further comprising a flexible protection member covering the twining portions of the two conductive members, wherein the flexible protection member is configured to expand and contract to correspond to the contracted state and the extended state of the conductive module.

9. The conductive module of claim 1, wherein the crossing segments of one of the two conductive members are arranged in an interlaced configuration with the crossing segments of the other of the two conductive members.

10. The conductive module of claim 1, wherein the twining portions of the two conductive members are flexible and bent in a serpentine manner to interlace with each other.

11. A power connector, comprising:
a housing defining an insertion slot;
two terminal modules respectively disposed within the housing, wherein each of the two terminal modules partially exposed from the insertion slot, and the two terminal modules are disposed facing each other; and
two conductive modules respectively connected to one of the two terminal modules, each of the two conductive modules comprising two conductive members, each of the two conductive members comprising a front fixing portion, a twining portion, and a rear fixing portion, wherein the twining portions of the two conductive members are intertwined with each other to define a plurality of crossing segments.

12. The power connector of claim 11, wherein each of the two conductive members is a flexible braided conductive strap having a flat ribbon shape.

13. The power connector of claim 12, wherein the flexible braided strap is formed by a plurality of conductive wire sets interlaced with each other.

14. The power connector of claim 13, wherein each of the plurality of conductive wire sets comprises a plurality of braided conductive wires.

15. The power connector of claim 11, wherein when each of the two conductive modules transitions from a contracted state to an extended state, a distance between the front fixing portion and the rear fixing portion of each of the two conductive members in an extended state is greater than that in a contracted state.

16. The power connector of claim 15, wherein upon transition of the conductive module from the contracted state to the extended state, a space defined between two adjacent crossing segments of the twining portions of each of the two conductive members in the extended state is greater than that in contracted state.

17. The power connector of claim 15, further comprises a flexible protection member covering the twining portions of the two conductive members, wherein the flexible protection member is configured to expand and contract to correspond to the contracted state and the extended state of the conductive module.

18. The power connector of claim 11, wherein when each of the two conductive modules transitions from a contracted state to an extended state, the twining portion extends and the rear fixing portion is extended away from the housing.

19. The power connector of claim 11, wherein the twining portions of the two conductive members are flexible and bent in a serpentine manner to interlace with each other.

20. The power connector of claim 11, wherein the crossing segments of one of the two conductive members are arranged in an interlaced configuration with the crossing segments of the other of the two conductive members.
